(19) United States
(12) Patent Application Publication
(10) Pub. No.: US 2025/0231986 A1
(43) Pub. Date: Jul. 17, 2025

(54) METHOD AND SYSTEM USING DIVERSE CAPTIONS FOR IMPROVING LONG VIDEO RETRIEVAL

(71) Applicant: SRI International, Menlo Park, CA (US)

(72) Inventors: Ajay DIVAKARAN, Monmouth Junction, NJ (US); Matthew Aaron GWILLIAM, College Park, MD (US); Michael COGSWELL, Yardley, PA (US); Karan SIKKA, Robbinsville, NJ (US); Meng YE, Pennington, NJ (US)

(21) Appl. No.: 18/980,001

(22) Filed: Dec. 13, 2024

Related U.S. Application Data
(60) Provisional application No. 63/620,676, filed on Jan. 12, 2024.

(51) Int. Cl. G06F 16/783; G06V 20/70

(52) U.S. Cl. CPC G06F 16/7844; G06V 20/70

(57) ABSTRACT

Embodiments of the present principles generally relate to methods, apparatuses, and systems for improved long video retrieval by training video language models (VLM) using diverse captions. In some embodiments, a method for improved long video retrieval may include generating a plurality of captions of varying dimensions using one or more Large Language Models (LLM); associating the plurality of captions of varying dimensions to one or more videos in one or more video data sets to generate one or more enhanced video data sets; generating an enhanced VLM by finetuning a pretrained video language model using the generated one or more enhanced video data sets; and retrieving one or more videos with a query using the enhanced VLM having a R@K rank.

### RELATED APPLICATION

This application claims benefit to U.S. Provisional Patent Application Ser. No. 63/620,676, filed 12 Jan. 2024 and entitled “Training and Benchmarking with Diverse Captions for Better Long Video Retrieval,” which is hereby incorporated herein in its entirety by reference.

### FIELD

Embodiments of the present principles generally relate to Large Language Models (LLMs) for videos and, more particularly, to methods and systems for training LLMs for videos using diverse captions for improved long video retrieval.

### BACKGROUND

Large Language Models (LLMs) are a type of artificial intelligence (AI) algorithm that uses deep learning techniques and massively large data sets to understand, summarize, generate and retrieve desired content. Existing long video retrieval systems using LLMs are trained and tested in the paragraph-to-video retrieval regime, where every long video is described by a single long paragraph. This neglects the richness and variety of possible valid descriptions of a video, which could range anywhere from moment-by-moment detail to a single phrase summary.

Existing approaches fail to model the variety of captions and show how they can be improved in the context of video retrieval. At its core, video retrieval requires not just a system that understands video and text, but also how minor differences between videos in a dataset make them unique. However, video retrieval literature traditionally considers just short clips which cannot be described by such a variety of captions, and thus obscures the problem. Increasingly more works have focused on long videos with multiple events, but it uses only full paragraphs for retrieval, neglecting the rich space of valid captions. While even existing captions can be ambiguous, they still do not include vague, abstract, or partial descriptions a user (e.g., doing video search) might give. This means current video retrieval datasets do not measure real world performance, where captions can be ambiguous, vary in semantics and style, and can describe long complex videos.

Thus, there is a need for improved techniques to train LLM's for improved long video search and retrieval from various styles, variations and types of queries.

### SUMMARY

Embodiments of the present invention generally relate to methods, apparatuses, and systems for improved long video retrieval by training video language models (VLM) using diverse captions. In some embodiments, a method for improved long video retrieval may include generating a plurality of captions of varying dimensions using one or more Large Language Models (LLM); associating the plurality of captions of varying dimensions to one or more videos in one or more video data sets to generate one or more enhanced video data sets; generating an enhanced VLM by finetuning a pretrained video language model using the generated one or more enhanced video data sets; and retrieving one or more videos with a query using the enhanced VLM having a R@K rank.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a block diagram of an exemplary computing system including components for a long video retrieval system in accordance with some embodiments of the present disclosure.

FIG. 2 depicts a flow diagram depicting a method for long video retrieval, in accordance with some embodiments of the present disclosure.

FIG. 3 depicts examples of synthetic captions created from ground truth captions, in accordance with some embodiments of the present disclosure.

FIG. 4 depicts text to long video retrieval performance in accordance with some embodiments of the present disclosure.

FIG. 5 is a simplified block diagram of a computer system in accordance with some embodiments of the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary and are not intended to limit what is presently disclosed. The features implemented in one embodiment may be implemented in another embodiment where logically possible. The specific details can be varied from and still be contemplated to be within the spirit and scope of what is being disclosed.

Embodiments of the present principles generally relate to methods, apparatuses and systems for training LLMs for videos using diverse captions for improved long video retrieval. In embodiments described herein, a novel 10 k Words technique for benchmarking and retrieval is provided which includes diverse descriptions generated for long videos with multiple events. As used herein, long videos may include videos that are 30 seconds or long, 60 seconds or longer, or in some embodiments, 120 seconds or longer. Key axes of variation for captions are identified, including simplification, summarization, and duration, then used to curate pools of captions with non-trivial differences in structure and semantics. The benchmark introduces challenging ambiguities, since some captions will not mention all the details that distinguish a video from similar, related videos. This benchmark is instantiated by augmenting/enhancing existing video datasets with diverse captions, creating enhanced 10 k words video datasets, and which work towards that richness of description with diverse synthetic captions. In some embodiments, these video caption augmentations are provided/generated by existing large language models (e.g., GPT3.5, etc.), which can be combined with some simple automatic manipulations to synthesize the diverse 10 k Words datasets as described further herein.

Embodiments consistent with the present principles use these 10 k Words enhanced video datasets in techniques/strategies to improve large video retrieval performance by performing contrastive finetuning for retrieval with video-caption pairs. This can provide an inexpensive boost to retrieval performance on both the 10 k datasets and the original standard datasets and be used to increase data efficiency. Using the above novel methods and systems, an LLM can be finetuned to improve retrieval performance returning the same video for various styles, variations and types of queries.

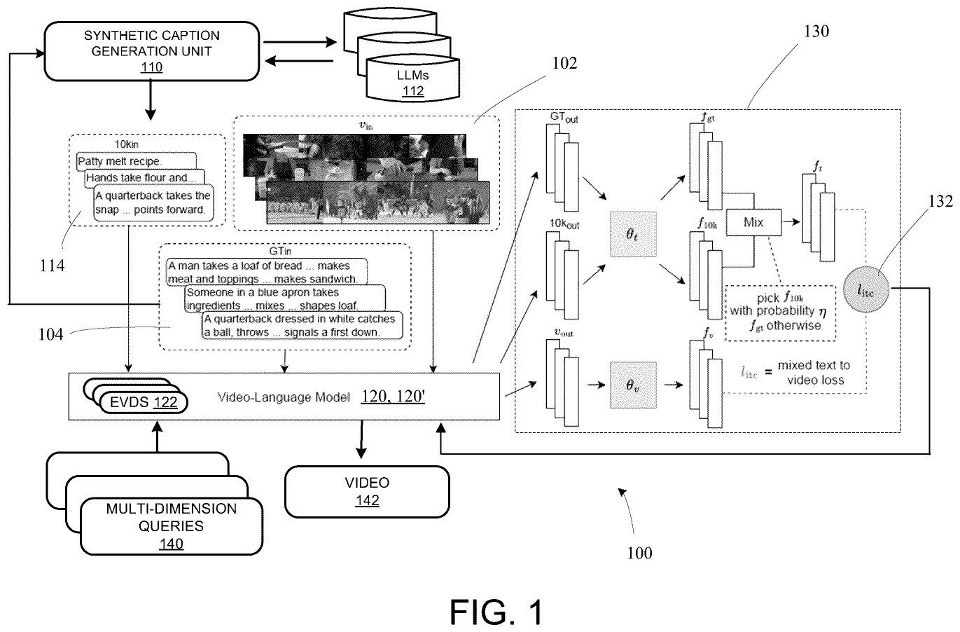

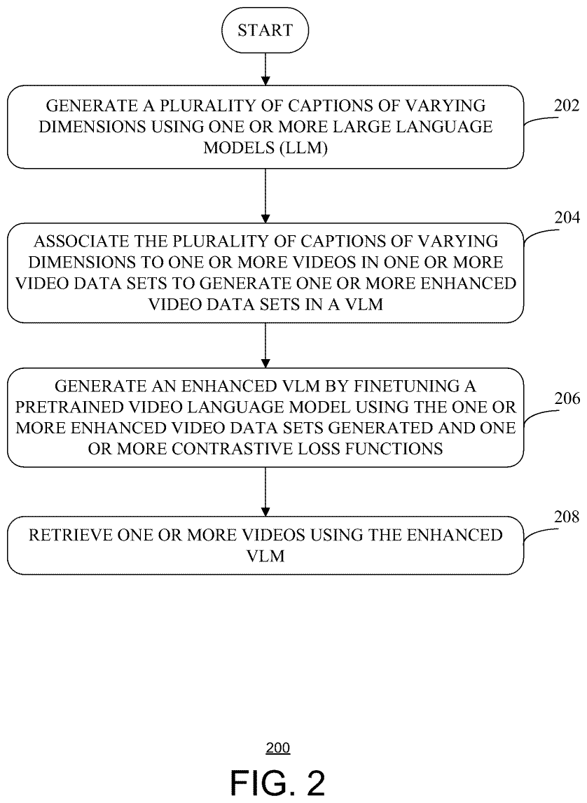

The aforementioned embodiments and features are now described below in detail with respect to FIGS. 1 and 2.

FIG. 1 depicts embodiments of a long video retrieval system 100 that improves long video retrieval by training video language models (VLM) using diverse captions. In some embodiments, the long video retrieval system 100 includes a synthetic caption generation unit 110 configured to generate a plurality of captions of varying dimensions (i.e., 10 k Words captions 114), 10 k Words enhanced video datasets (EVDS) 122 which are stored in association with video-language model (VLM) 120, and VLM finetuning unit 130 configured to create an enhanced VLM 120′ using the one or more EVDS 122 generated and one or more contrastive loss functions 132.

In operation, as shown in the flow chart of FIG. 2, the method for improved long video retrieval 200 by the long video retrieval system 100 begins at 202 where the synthetic caption generation unit 110 generates the synthetic 10 k Words captions 114, which are a plurality of captions of varying dimensions, for videos in existing video data sets 102. It does this by using standard existing ground truth (GT) captions 104 along with existing large language models 112 to produce the synthetic 10 k Words captions 114. In some embodiments, these video caption augmentations are natural language descriptions provided/generated by existing LLMs (e.g., GPT3.5, etc.), which can be combined with automatic manipulations to synthesize and generate the diverse 10 k Words datasets 114. The synthetic 10 k Words captions 114 generated include a plurality of captions of varying dimensions for the same video. In some embodiments, varying dimensions include varying duration level, summarization level, or simplification level, wherein each of the plurality of captions associated with each video differs by at least one of a duration level, summarization level, or simplification level. In some embodiments, varying the dimension so the captions may include simplifying the captions, complicating the captions, summarizing, and/or using only a portion of the captions (duration).

Other examples of varying dimension may include synonymic/paraphrasing dimensions and/or time dimensions. Synonymic/paraphrasing dimensions would replace words in a caption with similar words essentially paraphrasing it. Time dimensions would rearrange video clips so some actions switch places. For example, cutting the bread after frying the bacon for a sandwich. The corresponding captions would be rearranged in a corresponding manner and the retrieval system would need to retrieve the original video for the original caption and it would need to retrieve the modified video from the modified caption.

Other dimensions could include abstractness. Using this dimension, captions would be made more abstract (referring to general qualities of the video) or more concrete (referring to specific items in the video) and all captions would need to retrieve the same videos. In general, the criteria for any dimensions used above is that a varying captions along a given dimension should not lose so much information as to no longer identify the video of interest in any way.

After the 10 k Words captions 114 with varying dimensions are generated, at 204, the 10 k Words captions 114 are associated with each of the one or more videos in the one or more video datasets 102 to generate one or more enhanced video datasets 122. In some embodiments described herein, a plurality of captions of varying dimensions are associated with the same video. That is, in some embodiments, each of the plurality of captions associated with each video is a different description of the same video. The EVDS 122 are stored in association with VLM 120. In some embodiments, the enhanced video datasets 122 may be stored directly in VLM 120. In other embodiments the enhanced video datasets 122 may be stored separately but accessible by VLM 120.

At 206, an enhanced VLM 120′ is generated by VLM finetuning unit 130 by finetuning the video language model 120 using the one or more enhanced video data sets 122 generated and one or more contrastive loss functions 132. In some embodiments, the contrastive loss functions 132 are standard bi-directional contrastive loss functions that push the relationship between caption embeddings generated for the same video but different captions closer together.

At 208, one or more videos 142 are retrieved using the enhanced VLM 120′. Specifically, in some embodiments, the same video 142 may be retrieved from VLM 120′ using a plurality of different search queries 140 have varying dimensions which are variations on how to query the enhanced VLM. In some embodiments, a query may be a user query, a system query, or other type of query based on certain parameters for the search.

Text-to-video recall is primarily used to measure performance. Recall at K (i.e., R@K) is a metric used to evaluate retrieval (search) systems. The way a retrieval system works is that it is given a query (in this case a caption or piece of text) and a database (in this case a list of videos), it ranks the items in the database by their relevance to the query, with the rank 1 item being the one the system thought was most relevant. To evaluate a retrieval system, a list of queries is associated with ground truth database items which they are relevant to. The R@K metric looks at a query and calls it a match if the system ranks its ground truth item at rank K or better. Then R@K is the percent of queries which are matches. That is, given a list of text queries and video targets relative to a database of videos to be retrieved, R@K measures the percentage of queries for which the ground truth target was retrieved at rank K. R values may include R@1, R@5, and R@10. This is used to measure overall performance, but also to measure subset performance on Summarization and Simplification by considering the appropriate subsets of captions. In some embodiments, the one or more videos returned have a K<=X, where X is a predefined value. In some embodiments, the one or more videos returned have a K=1, K<=5, or a K<=10.

Further details of some of the operations and components of the long video retrieval system 100 are provided below.

Specifically, with respect to the generation of the 10 k Words captions 114 and EVDS 122, given an existing dataset of videos and corresponding descriptions, a 10 k version of the dataset (i.e., EVDS 122) by enriching the set of descriptions to cover more possible ways to describe the videos. Existing public video datasets 102 (e.g., ActivityNet, QuerYD, and LF-VILA), often take a long video and annotate E events e₁, e₂, . . . , e_{E} individually. Each event eᵢ has a corresponding short video clip vᵢ and is annotated with a natural language description of that clip tᵢ, with the set of clips and texts for a given video being denoted V and T. As such, the original long caption could be a paragraph, long sentence, or, more typically, the concatenation of video segment captions, which is then treated as a paragraph.

To cover the broadest possible spectrum of natural language queries for a video, in some embodiments, three augmentation axes are defined along which a video's description can vary: duration, summarization, and simplification. Duration refers to how many of the events in a video are described by a given query, while summarization and simplification cover different ways of using language to describe the same video. For each axis, a function is implemented that takes a video with event segmentation and descriptions as input and outputs a new augmented version of the same video with a new set of segments and descriptions which becomes part of an enhanced video dataset 122.

Summarization. Descriptions of videos can vary in length. While at one extreme they describe every detail in the video, at the other they briefly describe the main idea, leaving out some significant details. In between the two extremes, relevant details are progressively grouped and redundant elements are pruned. At one end of this spectrum a video retrieval model must be able to parse details and at the other end it must be able to understand a gestalt. To augment a video on this axis, one or more LLMs 112 are prompted with the ground truth descriptions T (concatenated) (i.e., 104 in FIG. 1) and instructed to generate summaries. For example, if the concatenated description has L words, then the LLM 112 is prompted to generate three summaries with

$$\vert L \cdot \frac{l}{7} \vert$$

words each for 1∈{1, 4, 7}. At full length (l=7) this should just re-phrase the concatenated caption, but at smaller lengths the LLM must leave out information. For example, in some embodiments, the inventors observed that GPT-3.5X is able to achieve the desired word count. This only changes T, leaving E and V unchanged. The above set of lengths (i.e., {1, 4, 7}) used are for example only and are non-limiting. Other lengths may be used. In addition, this may apply to the simplification dimension further described below.

Simplification. Descriptions of videos can vary in terms of their conceptual simplicity, where an idea could be described at the level of a college graduate, or else simplified for a kindergartener, and a good retrieval model should map all these descriptions to the same video. This dimension is captured by providing an LLM with the same ground truth description as for summarization and instructed it to output a simplified version. This is done for three levels of reading comprehension described to the LLM as “elementary”, “intermediate”, or “university” reading level. This only changes T, leaving E and V unchanged.

Duration. Descriptions of videos can be partial, intending to cover only a segment of the video, but the video can still be retrieved when these are used as queries. In the dataset used herein, this is implemented by choosing a contiguous subset of events \tilde{E}=eᵢ, . . . , eⱼ with start and end index i and j. The corresponding set of video clips \tilde{V} and captions \tilde{T} are selected to create the augmented video.

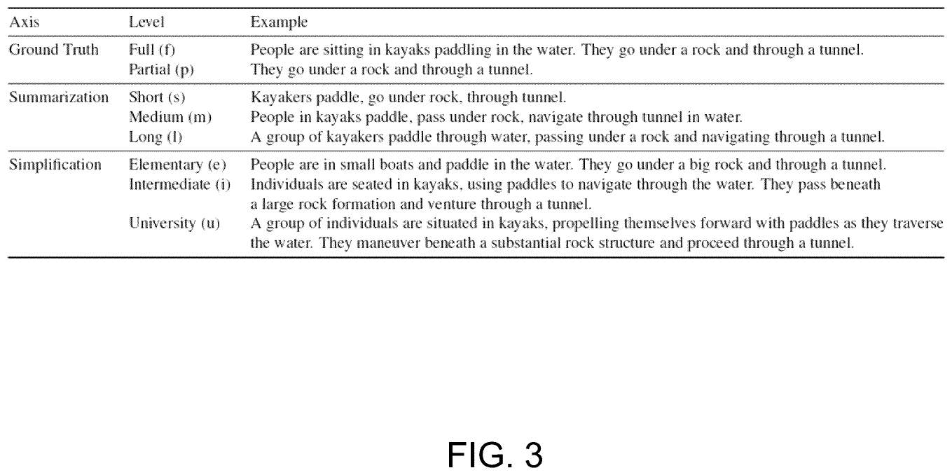

See FIG. 3 showing examples of synthetic captions of varying dimensions created from ground truth captions. Addition examples of varying dimensions of captions are provided and described below in accordance with Table 1. In the examples below, a ground truth (GT) is first provided. Then, captions with varying dimensions (e.g., summarization and simplification) with different lengths (e.g., {1, 4, 7}) are generated.

TABLE 1
Varying Dimensions Of Summarization And Simplification

| Label | Corresponding dimension in paper |
|---|---|
| **SUMMARY 1:** | Summarization-Short |
| **SUMMARY 4:** | Summarization-Medium |
| **SUMMARY 7:** | Summarization-Full length |
| VERSION primary school: | Simplification-Primary |
| VERSION secondary school: | Simplification-Secondary |
| VERSION university: | Simplification-University |
| Simplification VERSION | Summarization and Simplification |
| primary school: | (S and P) |
| Simplification VERSION | Summarization and Simplification |
| secondary school: | (S and S) |
| Simplification VERSION | Summarization and Simplification |
| university: | (S and U) |

Example 1: The ground truth caption for Example Video 1 states: A cookie is shown on a plate. Ingredients are being added to a glass bowl and being mixed together. Chocolate chips are added to the dough. The dough is flattened out onto a cookie sheet. Chocolate is drizzled over the top. Candies are placed on top of the cookie. The cookie is cut and placed on a plate. A fork is shown eating the cookie.
SUMMARY 1: A cookie is shown with chocolate drizzle and candies added.
SUMMARY 4: A cookie sits on a plate. Ingredients are mixed in a glass bowl. Chocolate chips are added, and dough is flattened on a sheet. Chocolate drizzle decorates the top before candies are placed. The cookie is cut, and a fork eats it.
SUMMARY 7: A cookie is displayed on a plate. Ingredients are mixed together in a glass bowl, forming dough. Chocolate chips are incorporated into the dough, which is then flattened onto a cookie sheet. Chocolate is drizzled over before candies are placed on the cookie. The result is cut and positioned on a plate. Finally, a fork is shown, eating the cookie, emphasizing the dessert's delightful presentation and taste.
VERSION primary school: A cookie is sitting on a plate. In a big glass bowl, ingredients are being mixed together. Then, yummy chocolate chips join the dough. The dough is pressed flat onto a cookie sheet. Some melted chocolate is drizzled over the dough, and colorful candies are placed on top. After baking, the cookie is cut into pieces and placed on a plate. A fork comes in to taste the cookie.
VERSION secondary school: The scene starts with a cookie on a plate. Ingredients get added to a large glass bowl and are mixed thoroughly. Chocolate chips are stirred into the dough. Then, the dough is spread across a cookie sheet. A drizzle of chocolate is poured over the dough, followed by candies on top. Once it's baked, the cookie is sliced and placed on a plate. A fork is seen eating the cookie.
VERSION university: A cookie rests atop a plate. Nearby, ingredients are incrementally integrated within a glass bowl and subsequently mixed. Chocolate chips are folded into the dough. This mixture is then evenly distributed across a cookie sheet's surface. Melted chocolate is artfully drizzled above, and candies are carefully arranged. Following baking, the cookie is sliced and elegantly positioned on a plate. The scene concludes with a fork delicately consuming a piece of the cookie.
Simplification VERSION primary school (S and P): Cookie ingredients are mixed, baked, topped with chocolate and candies.
Simplification VERSION secondary school (S and S): Cookie dough is prepared, chocolate drizzled, and candies added.
Simplification VERSION university (S and U): Ingredients mixed, dough baked, chocolate chips added, and sliced cookies served.

The above captions of varying dimensions would be associated all with the same video in the long video retrieval system 100. As a result of this and the processes described herein, queries of varying dimensions would be able to pull up the same video.

Example 2: The ground truth caption for Example Video 2 states: Players are holding a flat bat and running towards the balls. The players bounced the balls on the bat, some of them picked up the balls from the ground using the bat. The girl in blue jacket bounced the ball on her bat and she walked forward, but the ball fall on the ground. A girl in the black vest is picking up the ball from the ground using her bat. Two girls walked normally without chasing the balls. A girl on the field is trying to pick up the ball. The players are lined up and ready to pick up the balls from the ground using their bats. The players started to bounce their balls on their bat while running forward, some of the balls fell down on the ground and the players have to pick them up using the bat.
SUMMARY 1: Players run and bounce balls on bats, picking up fallen balls.
SUMMARY 4: The players are actively engaged in bouncing balls on their bats while running. Some players pick up balls from the ground using their bats. A girl in a blue jacket tries but fails, while others succeed. Two girls not chasing balls walk normally.
SUMMARY 7: The scene involves players using flat bats to engage with balls. They bounce balls on their bats while moving, attempting to keep them airborne. Some players succeed, though occasionally balls fall, and they retrieve them from the ground with their bats. A girl in a blue jacket attempts unsuccessfully. Two girls in the group walk without engaging with the balls. There is a focus on coordination and balance as players attempt to maneuver effectively.
VERSION primary school: The players are holding flat bats and running to bounce balls on them. A girl in a blue jacket tries to keep her ball bouncing, but it drops. Another girl in a black vest picks up a ball with her bat. Two girls walk without chasing balls. Everyone lines up to pick up balls using their bats. When running, some balls fall, and players pick them up with their bats.
VERSION secondary school: The players are using flat bats to bounce balls as they run. A girl in a blue jacket drops her ball while walking and bouncing it. Another girl, wearing a black vest, is picking up a ball with her bat. Two girls are just walking casually. The players then line up, ready to retrieve balls with their bats. As they run forward, some balls fall, requiring players to pick them up using their bats.
VERSION university: The players hold flat bats, running to bounce balls. A girl in a blue jacket drops her ball while moving forward. Meanwhile, a girl in a black vest retrieves her ball using a bat. Two others walk without engaging in the activity. Players line up, ready to collect balls using only their bats. While advancing and bouncing, multiple balls fall, necessitating players to retrieve them again with their bats.
Simplification VERSION primary school (S and P): Players hit balls, bounce on bats, some balls fall down.
Simplification VERSION secondary school (S and S): Players run with bats, bouncing balls, some dropping and picking.
Simplification VERSION university (S and U): Participants run with bats, bouncing balls occasionally dropping, retrieving them.

Example 3: The ground truth caption for Example Video 3 states: There are two kids on the swing set while two old ladies standing beside them swinging them. The old lady in pink top went away, while the other old woman in purple continues to swing the boy. The old lady in pink shirt went back with a piece of paper to fan some air on her, while a little kid is walking towards the front of the bench. The old lady in purple continues to swing the boy, while the old lady in pink top stood and rest her back on the red bar of the swing. The lady in pink top came in front of the other boy with white shirt, and talked to him, started to push him on the swing, give him a kiss and continue to swing him from the side of the swing. The little girl near the bench sat to pick up something from the blue ground.
SUMMARY 1: Two women swing kids; one leaves, then returns with paper.
SUMMARY 4: Two old ladies swing kids on the swing set. The woman in pink temporarily leaves and returns with paper. She fans herself and rests against the bar. Later, she talks to and swings a boy, kissing him affectionately.
SUMMARY 7: At a swing set, two old ladies push kids on swings. One leaves, returns with paper, and fans herself before resting against the red swing bar. She then talks and plays with a boy, giving him a kiss. Meanwhile, a little girl near the bench picks up something from the blue ground. The other lady in purple continues to swing a boy throughout the scene.
VERSION primary school: Two kids are on the swings. An old lady in a pink top leaves, and the one in purple keeps pushing the boy. The lady in pink returns with a paper to fan herself. A little girl near the bench sits on the blue ground to pick something up. The pink lady talks to a boy in a white shirt, kisses him, and pushes his swing.
VERSION secondary school: Two kids are on swings while two elderly women stand beside them. The woman in a pink top leaves, and the one in purple continues pushing the boy. The pink lady returns, fans herself with paper, and rests against the red swing bar. She approaches a boy in a white shirt, talks to him, kisses him, and pushes him on the swing. Nearby, a little girl sits, picking something off the blue ground.
VERSION university: Two children are on swings, assisted by two elderly women. The woman in the pink top departs, leaving the one in purple to push the boy. The pink-shirted woman returns, using paper to fan herself, and leans against the red swing bar. She engages a boy in a white shirt, kisses him, and resumes pushing him. Meanwhile, a little girl approaches the bench and bends to retrieve an item from the blue ground.
Simplification VERSION primary school (S and P): Two ladies push children on swings; one hugs, kisses.
Simplification VERSION secondary school (S and S): Women push kids on swings; one woman fans herself gently.
Simplification VERSION university (S and U): Two elderly women interact with children on swings, fanning herself.

Enhanced Video Datasets (EVDS 122, also referred to as 10 k Datasets). The above axes are combined to construct enhanced video datasets 122. In some embodiments, the EVDS 122 are constructed by taking the per-segment captions available for the standard video datasets 102 and input into one or more LLMs 112 with relevant prompts. Starting from each video in a base dataset video datasets 102, a plurality of captions is associated with each video. For example, 1 full caption (original ground truth paragraph), 3 captions for the levels of simplification (elementary, intermediate, and university), 3 captions for the levels of summarization (short, medium, and long), 3 captions that combine summarization and simplification by generating simplifications for the short summaries, and 1 caption corresponding to a random subset of the original video segments by duration augmentation.

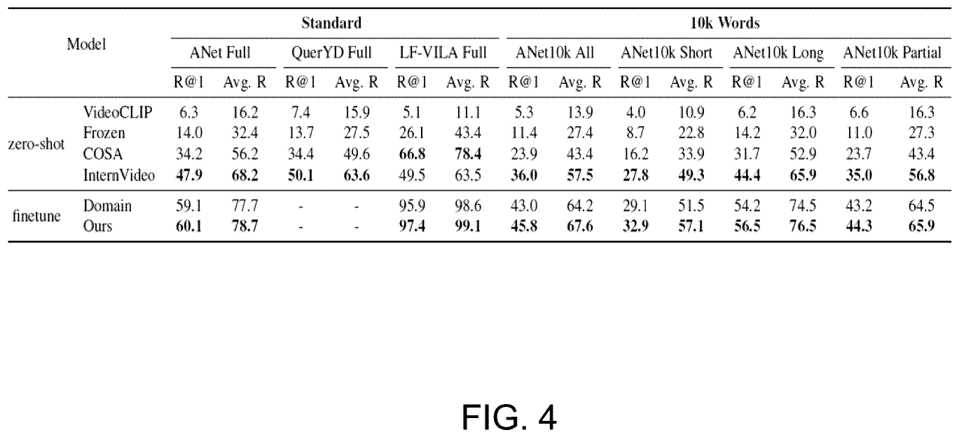

Dataset Analysis and Benchmark Results: In the following section some fine-grained statistical measures are presented in FIG. 4. More specifically, in the above, it was shown that the captions generated in system 100 are diverse and robust. In this section, it is demonstrated that they are useful for benchmarking the text-to-video retrieval performance of video-language models.

Overall, the long video retrieval system 100 shows at least an improvement of +2.8% R@1 retrieval (with finetuning) versus the same model fine-tuned on just ActivityNet data, which is SOTA 10 k Words performance.

The measure of performance on the Duration axis is determined based on whether the partial and full captions can retrieve the full length video. The “Full” setting measures how often the full caption (f) retrieves the video at rank K or better, which represents performance as measured by the standard datasets. The “Partial” setting measures how often the partial caption (p) retrieves the same full length video. The “Short” setting measures performance of full length video retrieved by short captions including short summarization (s) and simplifications of it (s+e, s+i, s+u). Similarly, performance on the “Long” setting is also reported which include long summarization (l) and simplifications of it (l+e, l+i, l+u). The “All” setting is an average of Partial, Short, and Long, weighted by the number of caption types for each.

Improving Performance by finetuning the video-language model 120 to create an enhanced video-language model 120′. Baseline results are presented in FIG. 4 where pre-trained video-language model 120 is finetuned which further improves retrieval of videos from text queries. Embodiments consistent with the present disclosure provide at least two ways to leverage the data to improve these results. The first is at training time—with no extra cost in terms of parameters, iterations, or FLOPS, training can be performed with synthetic captions to improve retrieval results. The second is at inference time—the 10 k prompts can be leveraged as a form of query expansion, and aggregate the retrievals across equivalent 10 k captions.

Training-time Improvements. As described above, the system 100 can perform finetuning of video-language models using contrastive loss functions. For example, finetuning can be performed on COSA and InternVideo, which are two existing video language models, in addition to VideoCLIP and Frozen (i.e., standard video-language models without enhanced captions or finetuning as described herein). A batch of videos is sampled with corresponding captions and apply a loss that pushes matching video and caption embeddings closer together. To encourage the model to associate all of the descriptions for a video with that video, the synthetic captions are also included for a video during training.

Specifically, as shown in the VLM finetuning unit 130 in FIG. 1, for every video, (i) the ground truth paragraph, and (ii) a random 10 k Words caption is sampled. The two sets of captions are mixed, taking one caption per video, to yield our primary text features, fₜ, ensuring that a fixed percentage (set by a mixing ratio, η) are 10 k Words captions, and the rest are ground truth (GT). Using these primary text features, a standard bi-directional contrastive loss 132 is computed with the video features as in COSA and Intern-Video.

FIG. 4 shows the results for COSA finetuning on ActivityNet (“Domain”). It is observed that finetuning by sampling from 10 k Words data yields considerable improvements for retrieving with 10 k Words captions. The inventors have also found that these findings hold when the data sampling and losses are adapted for other state-of-the-art models (e.g., such as Intern-Video), as well as when finetuning on other video datasets, such as LF-VILA.

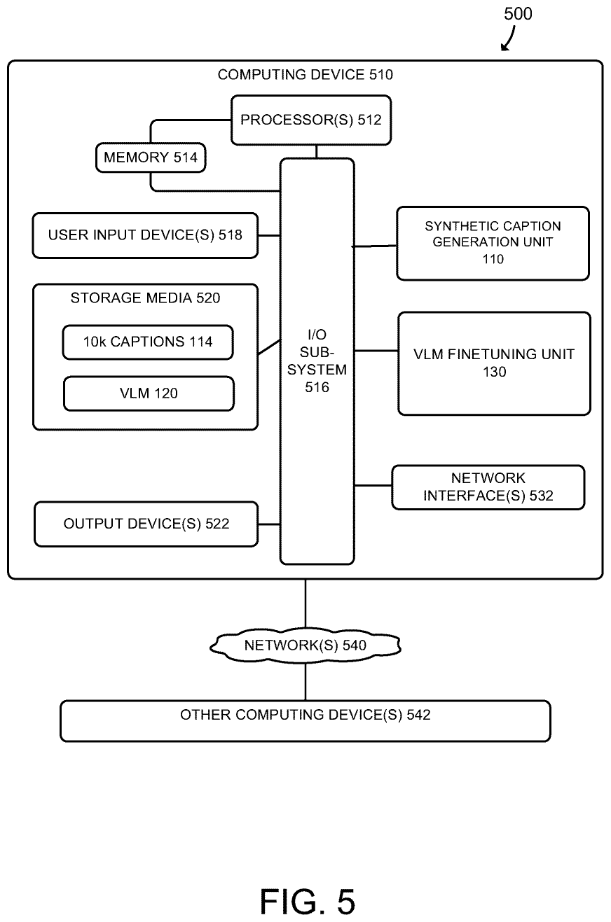

Referring now to FIG. 5, a simplified block diagram of an exemplary computing environment 500 for the long video retrieval system 100. The illustrative implementation 500 includes a computing device 510, which may be in communication with one or more other computing systems or devices 542 via one or more networks 540. In some embodiments, portions of the system 100 may be incorporated into other systems or interactive software applications or work with such systems or applications. Such applications or systems may include, for example, operating systems, middleware or framework (e.g., application programming interface or API) software, and/or user-level applications software (e.g., a search engine, a virtual personal assistant, a messaging application, a web browser, another interactive software application or a user interface for a computing device).

The illustrative computing device 510 includes at least one processor 512 (e.g. a microprocessor, microcontroller, digital signal processor, etc.), memory 514, and an input/output (I/O) subsystem 516. The computing device 510 may be embodied as any type of computing device such as a personal computer (e.g., a desktop, laptop, tablet, smart phone, wearable or body-mounted device, etc.), a server, an enterprise computer system, a network of computers, a combination of computers and other electronic devices, or other electronic devices. Although not specifically shown, it should be understood that the I/O subsystem 516 typically includes, among other things, an I/O controller, a memory controller, and one or more I/O ports. The processor 512 and the I/O subsystem 516 are communicatively coupled to the memory 514. The memory 514 may be embodied as any type of suitable computer memory device (e.g., volatile memory such as various forms of random access memory).

The I/O subsystem 516 is communicatively coupled to a number of components including one or more user input devices 518, one or more storage media 520, one or more output devices 522 (e.g., display screens, speakers, LEDs, etc.), one or more synthetic caption generation unites 110, one or more VLM finetuning modules 130, and one or more network interfaces 532.

The storage media 520 may include one or more hard drives or other suitable data storage devices (e.g., flash memory, memory cards, memory sticks, and/or others). In some embodiments, portions of systems software (e.g., an operating system, etc.), framework/middleware (e.g., APIs, object libraries, etc.) in the storage media 520. In some embodiments, the 10 k captions 114 generated reside in the storage media 520. In some embodiments, the VLM 120 and/or enhanced VLM 120′ reside in the storage media 520.

The one or more network interfaces 532 may communicatively couple the computing device 510 to a network, such as a local area network, wide area network, personal cloud, enterprise cloud, public cloud, and/or the Internet, for example. Accordingly, the network interfaces 532 may include one or more wired or wireless network interface cards or adapters, for example, as may be needed pursuant to the specifications and/or design of the particular computing system 500. The network interface(s) 532 may provide short-range wireless or optical communication capabilities using, e.g., Near Field Communication (NFC), wireless fidelity (Wi-Fi), radio frequency identification (RFID), infrared (IR), or other suitable technology.

The other computing system(s) 542 may be embodied as any suitable type of computing system or device such as any of the aforementioned types of devices or other electronic devices or systems. The computing system 500 may include other components, sub-components, and devices not illustrated in FIG. 5 for clarity of the description. In general, the components of the computing system 500 are communicatively coupled as shown in FIG. 5 by electronic signal paths, which may be embodied as any type of wired or wireless signal paths capable of facilitating communication between the respective devices and components.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

The foregoing methods and embodiments thereof have been provided in sufficient detail but it is not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

This disclosure is to be considered as exemplary and not restrictive in character, and all changes and modifications that come within the guidelines of the disclosure are desired to be protected.

1. A method for improved long video retrieval by training video language models (VLM) using diverse captions, the method comprising:
generating a plurality of captions of varying dimensions using one or more Large Language Models (LLM);
associating the plurality of captions of varying dimensions to one or more videos in one or more video data sets to generate one or more enhanced video data sets;
generating an enhanced VLM by finetuning a pretrained video language model using the generated one or more enhanced video data sets; and
retrieving one or more videos with a query using the enhanced VLM having a R@K rank.

2. The method according to claim 1, wherein each of the one or more video data sets include a plurality of long videos greater than 60 seconds or contain multiple events.

3. The method according to claim 1, wherein each of the plurality of captions associated with each video is a different description of the video.

4. The method according to claim 1, wherein the varying dimensions include varying duration level, summarization level, or simplification level, wherein each of the plurality of captions associated with each video differs by at least one of a duration level, summarization level, or simplification level.

5. The method according to claim 1, wherein one or more of the plurality of captions are natural language descriptions generated by the one or more LLMs.

6. The method according to claim 1, wherein the enhanced VLM is further finetuned using one or more contrastive loss functions.

7. The method according to claim 6, wherein the contrastive loss functions are standard bi-directional contrastive loss functions that push the relationship between caption embeddings generated for the same video closer together.

8. The method according to claim 1, wherein the same video is retrieved from the enhanced VLM using a plurality of different search queries have varying dimensions which are variations on how to query the enhanced VLM.

9. The method according to claim 1, wherein K=1.

10. The method according to claim 1, wherein K<=5.

11. A long video retrieval system comprising:
a synthetic caption generation unit configured to generate a plurality of captions of varying dimensions;
one or more enhanced video data sets created by associating the plurality of captions of varying dimensions to one or more videos in one or more existing video data sets;
a video language model finetuning unit configured to finetune a pretrained video language model using the generated one or more enhanced video data sets; and
an enhanced video language model (VLM) configured to retrieve one or more long videos with a query having a R@K rank.

12. The system according to claim 11, wherein each of the one or more video data sets include a plurality of long videos greater than 60 seconds or contain multiple events.

13. The system according to claim 11, wherein each of the plurality of captions associated with each video is a different description of the video.

14. The system according to claim 11, wherein the varying dimensions include varying duration level, summarization level, or simplification level, wherein each of the plurality of captions associated with each video differs by at least one of a duration level, summarization level, or simplification level.

15. The system according to claim 11, wherein one or more of the plurality of captions are natural language descriptions generated by one or more LLMs.

16. The system according to claim 11, wherein the enhanced VLM is further finetuned using one or more contrastive loss functions.

17. The system according to claim 16, wherein the contrastive loss functions are standard bi-directional contrastive loss functions that push the relationship between caption embeddings generated for the same video closer together.

18. The system according to claim 11, wherein the same video is retrieved from the enhanced VLM using a plurality of different search queries have varying dimensions which are variations on how to query the enhanced VLM.

19. The system according to claim 11, wherein K=1 or K<=5.

20. A non-transitory computer readable medium for storing computer instructions that, when executed by at least one processor causes the at least one processor to perform a method for improved long video retrieval by training video language models (VLM) using diverse captions, the method comprising:
generating a plurality of captions of varying dimensions using one or more Large Language Models (LLM);
associating the plurality of captions of varying dimensions to one or more videos in one or more video data sets to generate one or more enhanced video data sets;
generating an enhanced VLM by finetuning a pretrained video language model using the generated one or more enhanced video data sets; and
retrieving one or more videos with a query using the enhanced VLM having a R@K rank.
